(19) United States
(12) Patent Application Publication
(10) Pub. No.: US 2012/0045068 A1
(43) Pub. Date: Feb. 23, 2012

(54) SELF-FAULT DETECTION SYSTEM AND METHOD FOR MICROPHONE ARRAY AND AUDIO-BASED DEVICE

(75) Inventors: Jinsung Kim, Seoul (KR); Bum-Jae You, Seoul (KR)

(73) Assignee: KOREA INSTITUTE OF SCIENCE AND TECHNOLOGY, Seoul (KR)

(21) Appl. No.: 12/860,510

(22) Filed: Aug. 20, 2010

(51) Int. Cl. H04R 29/00

(52) U.S. Cl. 381/58

(57) ABSTRACT

Disclosed herein is a self-fault detection system and method in a microphone array system, in which features for self-fault detection of a microphone array are formed using internal values of a voice activity detector (VAD) with respect to audio signals respectively outputted from a plurality of microphones, the features generated with respect to each of the microphones are mutually and automatically compared without a special reference signal, thereby self-detecting fault microphones.

### BACKGROUND

1. Field of the Invention

Disclosed herein are a self-fault detection system and method for a microphone array and an audio-based device. More particularly, disclosed herein are a self-fault detection system and method in a microphone array system using a voice activity detector (VAD) and an audio-based device including a self-fault detector in a microphone array system using a VAD.

2. Description of the Related Art

As the life of human beings is improved with the development of scientific technologies, various studies have been conducted to develop systems for improving the life quality of human beings. A variety of systems such as cellular phones and industrial and service robots are widely prevalent in our life, including electric appliances such as televisions and refrigerators, which developed a long time ago and have been continuously improved. While people learned how to operate systems and directly handle them as a machine-oriented interaction in the past, people-oriented, simple and easy operating methods are used in spite of more complicated and various functions in modern times. As an example, while channels on a television were changed by turning its channel handle in the past, they are conveniently changed for a very short time using a remote controller at present. In the near future, it is expected that such a remote controller will be improved to operate a television using voice that is the simplest and easiest way to transfer instructions in human beings. In the intelligent service robot market that is currently expanded, much interest is not focused on the development of unidirectional robots that provide one-sided help or information to users but focused on the development of human-friendly service robots that enable communications between users and robots. Therefore, it is important to conduct studies on voice-based interaction for human-friendly, convenient and smooth interaction. Accordingly, it is necessary to conduct studies on fault detection in a microphone array system.

As a practical example, when one of microphones in an intelligent system has a fault due to fire (heat), moisture (water), impact (collision), contact error (cable failure) or the like, a service robot and a mechanism may be controlled by distorted data including audio signals inputted to the fault-detected microphone. In this case, it is difficult to perform a normal operation, and a serious accident may occur due to the negligence of malfunction. If the best operation is performed under such an abnormal condition by performing a partial operation, by indicating the impossibility of operation, and the like, the intelligent system is very reliable. Therefore, it is very important to conduct studies on an intelligent system that can detect and handle a fault of a microphone so that if the fault of the microphone occurs, a proper countermeasure is taken.

However, fault detection in a microphone array that ensures the reliability of voice-based interaction has seldom been investigated, even though there has been much research on fault detection in induction motors, robot, manipulators, chillers, vessel monitoring systems, and network server equipment. Microphone faults have been considered unimportant despite progressive changes to the methods for providing command transmission to intelligent service robots.

### SUMMARY OF THE INVENTION

Disclosed herein is a self-fault detection system and method in a microphone array system using a voice activity detector (VAD), which can automatically detect faulty microphones in a microphone array in voice-based interaction without a specific calibration signal and a known sound source position. VAD is a general technique of speech signal processing to detect the presence or absence of speech from an audio signal and is used in most voice-based interaction systems.

Further disclosed herein is an audio-based device including a self-fault detector in a microphone array system using a VAD.

In embodiments, there is provided a self-fault detection system and method in a microphone array system using a VAD, in which features for fault detection, converted and normalized using the VAD, are formed with respect to audio signals respectively outputted from a plurality of microphones, and the features generated with each of the microphones are analyzed, thereby self-detecting faults of microphones. The features represent internal result values in VAD. Internal result values in VAD are used to determine whether or not voice is contained in one frame of an input signal.

In one embodiment, there is provided a self-fault detection system in a microphone array system, the system including: an audio signal input unit having a plurality of microphones through which audio signals are respectively inputted; a self-fault detector that analyzes the audio signals respectively inputted to the plurality of microphones and diagnoses, as faults, microphones to which corresponding audio signals with abnormal features are respectively inputted; and a control unit that controls the audio signals respectively inputted from the microphones diagnosed as the faults to be processed based on a reference for defect tolerance of a system with respect to the microphones diagnosed as faults by the self-fault detector.

In another embodiment, there is provided a self-fault detection method in a microphone array system, the method including: respectively inputting audio signals to a plurality of microphones; extracting internal result values of a VAD that determines the presence of voice for each frame of the audio signals respectively inputted to the plurality of microphones, thereby generating features for fault detection; and extracting abnormal features by analyzing and grouping the plurality of features formed with respect to each of the microphones, and diagnosing, as faults, microphones to which corresponding audio signals with the abnormal features are respectively inputted. In still another embodiment, there is provided an audio-based device including: an audio signal input unit having a plurality of microphones through which audio signals are respectively inputted; a self-fault detector that analyzes the audio signals respectively inputted to the plurality of microphones and diagnoses, as faults, microphones to which corresponding audio signals with abnormal features are respectively inputted; and a control unit that controls the audio signals respectively inputted from the microphones diagnosed as the faults to be processed based on a reference for defect tolerance of a system with respect to the microphones diagnosed as faults by the self-fault detector.

The control unit may determine one of a partial operation after stopping the operation of the fault microphones, a normal operation after replacing the fault microphones, and a declaration of stopping the entire operation based on the reference for defect tolerance of the system with respect to the microphones diagnosed as faults by the self-fault detector.

### BRIEF DESCRIPTION OF THE DRAWINGS

The above and other aspects, features and advantages disclosed herein will become apparent from the following description of preferred embodiments given in conjunction with the accompanying drawings, in which:

FIG. 1 is a configuration view of a self-fault detection system for a microphone array according to an embodiment;

FIG. 2A shows embodiments of voice input signals respectively inputted to a plurality of microphones, and FIG. 2B shows embodiments of features respectively converted and normalized by applying a feature generation unit using a voice activity detector (VAD) to the audio signals of FIG. 2A according to the embodiments;

FIG. 3 is a configuration view of an audio-based device according an embodiment;

FIG. 4 is a flowchart illustrating a self-fault detection method in a microphone array system according to an embodiment; and

FIG. 5 shows an embodiment of a robot having a plurality of microphones arrayed while being spaced apart from one another at a distance.

### DETAILED DESCRIPTION OF THE INVENTION

Exemplary embodiments now will be described more fully hereinafter with reference to the accompanying drawings, in which exemplary embodiments are shown. This disclosure may, however, be embodied in many different forms and should not be construed as limited to the exemplary embodiments set forth therein. Rather, these exemplary embodiments are provided so that this disclosure will be thorough and complete, and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

In the drawings, like reference numerals in the drawings denote like elements. The shape, size and regions, and the like, of the drawing may be exaggerated for clarity.

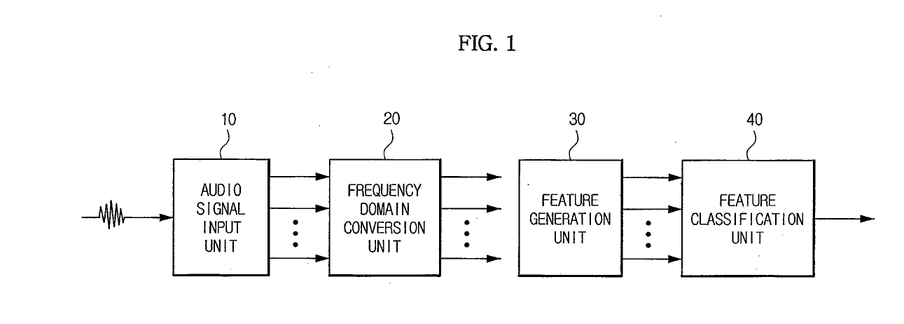

FIG. 1 is a configuration view of a self-fault detection system for a microphone array according to an embodiment.

Referring to FIG. 1, the self-fault detection system includes an audio signal input unit 10 having a plurality of microphones to which audio signals are inputted; a feature generation unit 30 that extracts an internal calculation value of a voice activity detector (VAD) for determining the presence of voice for the frame of each of the audio signals and generates a feature for fault detection with respect to each of the audio signals; and a feature classification unit 40 that extracts abnormal features by analyzing and grouping the features formed with respect to each of the microphones and diagnoses, as a fault, the microphone to which a corresponding audio signal with the abnormal feature is inputted.

In this case, the self-fault detection system may further include a frequency domain conversion unit 20 that converts audio signals in a time domain, inputted to the plurality of microphones, into ones in a frequency domain, respectively.

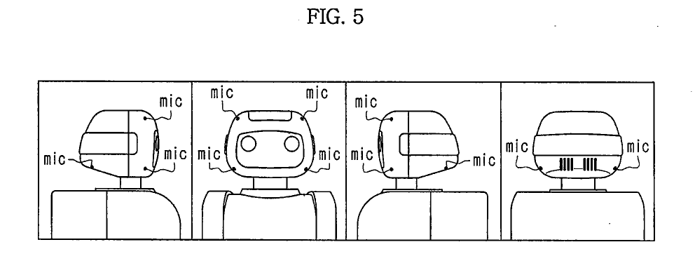

The audio signal input unit 10 includes a plurality of microphones. A microphone array using a plurality of microphones may be used in voice-based interaction such as sound source localization, blind source separation, and automatic speed recognition. Therefore, an audio signal is inputted to the plurality of microphones, so that outputs are generated by the plurality of microphones, respectively. In this case, the plurality of microphones may be arrayed to be spaced apart from one another at a distance. FIG. 5 shows an embodiment of a robot having a plurality of microphones arrayed while being spaced apart from one another at a distance. Referring to FIG. 5, the plurality of microphones are arranged to be spaced apart from one another at the distance, so that when an audio signal is generated, each of the microphones receives the generated audio signal. Arrows of FIG. 5 indicate the positions of the microphones.

The frequency domain conversion unit 20 converts the audio signals in a time domain, inputted through the audio signal input unit 10, into ones in a frequency domain. In this case, the frequency domain conversion unit 20 converts outputs of the audio signals respectively inputted to the plurality of microphones of the audio signal input unit 10 into ones in a frequency domain. A fast Fourier transform (FFT) unit may be used as an embodiment of the frequency domain conversion unit 20.

The self-fault detection system according to embodiment generates features for fault detection with respect to each frame of the input signals for each of the plurality of microphones, using the VAD. An abnormal feature is extracted by analyzing and grouping the plurality of features formed with respect to each of the microphones, and a microphone having a corresponding audio signal with the abnormal feature inputted thereto is diagnosed as a fault. The self-fault detection system may include the feature generation unit 30 and the feature classification unit 40, and may further include the frequency domain conversion unit 20.

The VAD disclosed herein is a technique used in voice signal processing fields, which distinguishes a section in which voice exists from an audio signal in which voice, noise and other signals are mixed together. An embodiment of the VAD will be described. However, this is provided only for illustrative purposes, and the scope disclosed herein is not limited to such an embodiment of the VAD. First, an inputted voice signal is necessarily analyzed for the purpose of voice signal processing. When assuming that the inputted voice signal includes voice and noise, the noise generally is uncorrelated noise. If it is assumed that a noise signal N is added to a voice signal S and their sum is X, the Fourier transformation is as follows:

X(k,t)=S(k,t)+N(k,t), k=1, 2, . . . , M (1)

Here, k denotes a k-th frequency, M denotes the number of entire frequency bands, and t denotes a frame index on the time axis. The basic assumption in the voice improvement approach is described by the following two equations 2 and 3:

H₀:X(k,t)=N(k,t) (2)

H₁:X(k,t)=N(k,t)+S(k,t) (3)

Here, X(t)=[X(1,t), X(2,t), . . . , X(M,t)]^{T}, N(t)=[N(1,t), N(2,t), . . . , N(M,t)]^{T} and S(t)=[S(1,t), (2,t), . . . , S(M,t)]^{T} of denote the discrete Fourier transform (DFT) coefficient vectors of a voice signal polluted with noise, a noise signal and an original voice signal, respectively. Also, T denotes a transpose. A statistical model-based VAD proposed to detect a voice frame from an input signal is used in the thesis. The voice and non-voice frames are determined by a decision rule such as the following equation 4 based on maximum likelihood:

$$\begin{matrix}{H}_{0} \text{:} log Λ = \frac{1}{T} {\sum }_{k} {γ}_{k} - log {γ}_{k} - 1 < η & ( 4 \text{-} a ) \\ {H}_{1} \text{:} log Λ = \frac{1}{T} {\sum }_{k} {γ}_{k} - log {γ}_{k} - 1 > η & ( 4 \text{-} b )\end{matrix}$$

Here, γₖ=|X(k)²/λₖ| denotes a posterior signal-to-noise ratio, ƒₛ=1/T denotes a sampling frequency, λ denotes a dispersion of noise, and η denotes a threshold. When the value of log Λ is greater than the threshold η, the frame H₁ is estimated as a frame in which voice is contained. Generally, only whether the log Λ for each frame is greater or smaller than the threshold η is binarized, and the binarized value is used in the VAD. On the contrary, in the embodiment, the internal value of the VAD, such as log Λ, is not used in the VAD but used in generating features for fault detection.

The fault state of a microphone, described in this specification, denotes all states in which the microphone cannot perform a normal operation, including the state that performance is degraded by the attenuation of a signal inputted to the microphone due to fire (heat), moisture (water), impact (collision), contact error (cable failure) or the like, the state that an irregular peak signal is contained in the signal inputted to the microphone, the state that there is no input signal due to the disconnection of a line of the microphone, and the like.

In the case of a voice-based interaction device, the device is controlled based on an audio signal inputted to a plurality of microphones. In this case, if all data for the plurality of microphones including a distorted audio signal of a fault microphone are also considered, and hence, the control of the device may be distorted. Therefore, it is necessary to detect the fault sate of a microphone by itself and to actively deal with the fault state to be suitable for conditions.

The feature generation unit 30 using the VAD generates a feature for fault detection using an internal result value, which distinguishes whether or not the corresponding frame is a voice frame.

In this case, the plurality of microphones may be arrayed at different positions, respectively. Therefore, although the same audio signal is inputted to the plurality of microphones, times delay and changes in amplitude may occur depending on the positions of the plurality of microphones, and hence, the audio signals respectively inputted to the plurality of microphones may not all be identical to one another. Accordingly, the generated feature may be changed. However, in the feature generation unit 30, conversion and normalization are performed for each frame of the input signal using the VAD, thereby minimizing changes in features with respect to the positions of the plurality of microphone and their signal distortion.

In the feature generation unit 30 using the VAD, features are generated by applying the VAD for each frame of the audio signals and calculating a representative value for each of the frames. Hence, a large amount of data in the time domain, inputted to the plurality of microphones, is remarkably reduced through the feature generation unit 30. In one embodiment, when an input signal received to a microphone is sampled at 16 kHz, the number of sample data contained in one frame is set as 2048, and features are generated by moving frames at an interval of 1024 sampled data, the number of data generated through the VAD, i.e., features, is reduced to 1/1024 of the number of data in the time domain, inputted by a microphone.

In the feature generation unit 30 using the VAD, the VAD is applied for each frame with respect to an audio signal inputted to the plurality of microphones. Thus, although the plurality of microphones are arrayed to be spaced apart from one another, it is possible to minimize changes in features due to the time delay caused with respect to the same input signal. In the embodiment, when an input signal received to a microphone is sampled at 16 kHz, the number of sample data contained in one frame is set as 2048, and features are generated by moving frames at an interval of 1024 sampled data, the interval of one sample means 62.5 μsec, and therefore, one frame means information for 128 msec (=62.5 μsec*2048). In spite of consideration of the interval of 1024 sample data, at which the frames are moved, the frame becomes information for 128 msec. This means that although the time delay of the signal inputted to the plurality of microphones becomes maximum 64 msec, changes in features for the time delay are not generated so much. If 64 msec that is the time delay of an audio signal is converted into a spacing distance between the microphones, the time at which the audio signal moves a distance of 1 cm is 29.4 μsec under the assumption that the velocity of sound is 340 m/sec. Hence, the spacing distance between the microphones means 2176.9 cm (i.e., 21.8 m). Thus, when it is considered that the interval at which microphones are arrayed in a general intelligent service robot is 1 m or less, 21.8 m is a very large value, and the features generated using the VAD are hardly influenced by the spacing distance between the microphones. In other words, there is little effect in the features on the time-delay between real speech signals of microphones.

The feature classification 40 classifies the features respectively corresponding to the plurality of microphones, formed by the feature generation unit 20 using the VAD, based on a predetermined reference. That is, the features respectively corresponding to the plurality of microphones are classified into normal and abnormal features, and microphones corresponding to the abnormal features are diagnoses as faults. The abnormal features mean features except a cluster classified into a normal group by similarity and the like in the generated features corresponding to the plurality of microphones, i.e., features that assume a different aspect from those of the normal group.

In the feature classification unit 40, the feature classification method of classifying the features generated using the VAD into the normal and abnormal features includes a cross-comparison method in which the similarity between features is determined by performing cross-comparison with respect to the features, a PCA classification method, an ICA classification method, an SVM classification method, and the like. This is provided only for illustrative purposes, and the scope disclosed herein is not limited to such an embodiment of the feature classification method.

The feature classification unit 40 diagnoses, as faults, the microphones corresponding to the features determined as the abnormal features through the feature classification.

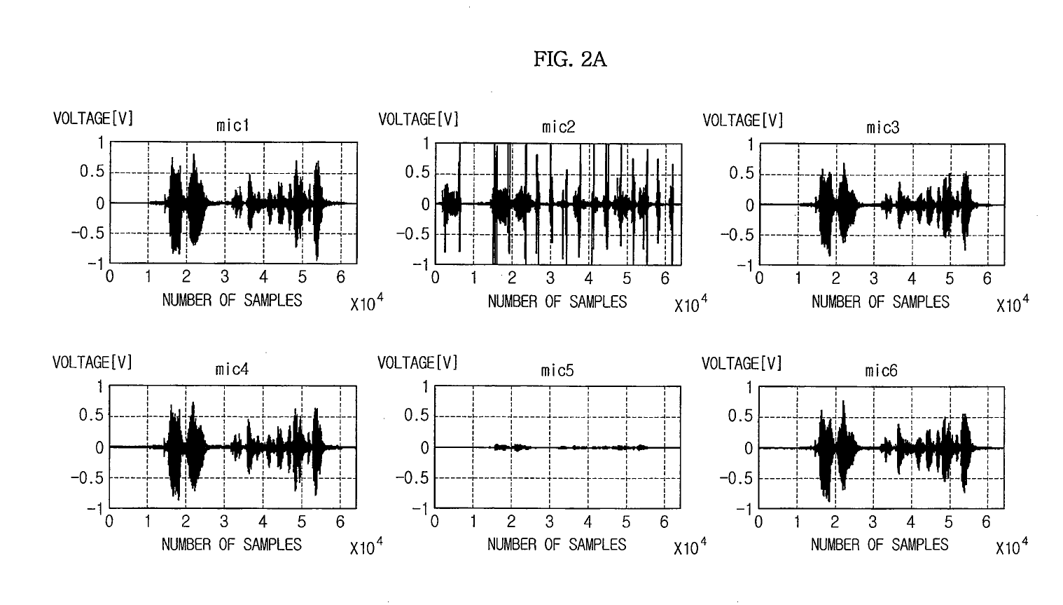

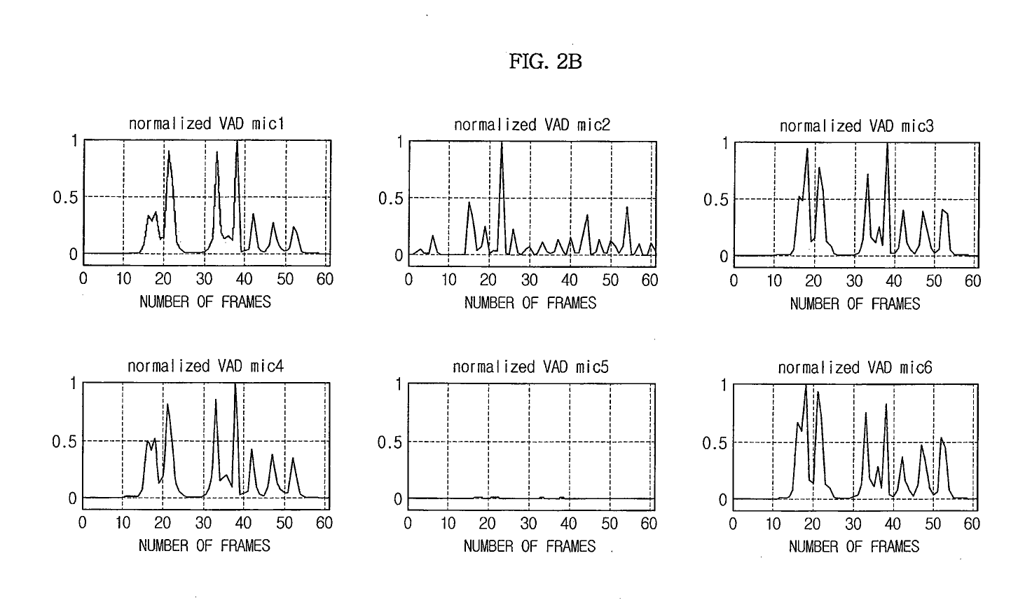

FIG. 2A shows embodiments of voice input signals respectively inputted to a plurality of microphones, and FIG. 2B shows embodiments of features for the audio signals of FIG. 2A generated in the feature generation unit 30 using the VAD according to the embodiments.

Referring to FIG. 2A, output signals respectively from microphone 1 to microphone 6 are shown. Since the output signals of FIG. 2A are signals in a time domain, each of the output signal is a data in which the number of samples is about 64,000, i.e., a data sampled at 16 kHz for four seconds. In order to perform cross-comparison with respect to the output signals, the amount of data to be processed is considerable, and the output signals are difficult to be used as features for fault detection due to the time delay caused by the positions of the plurality of microphones and their signal distortion.

Hereinafter, a feature generation method using the VAD will be described as an embodiment.

Representative values are extracted by setting 2048 sampled signals out of about 64,000 sampled signals as one frame and applying the VAD to every frame while moving in a lateral direction at an interval of 1024. In this case, the amount of data to be processed is reduced from about 64,000 sampled signals to about 62 frames.

Referring to FIG. 2B, features may be generated as result values converted and normalized by the VAD with respect to about 62 frames.

By using the feature classification method in the feature classification unit, the features of the respective microphone 1 to microphone 6 are classified into a normal feature group that includes features with similarity and an abnormal feature group that includes features with no similarity. In the embodiment of FIG. 2A, the features corresponding to the microphone 2 (mic2) and microphone 5 (mics) are classified as an abnormal feature group, and the features corresponding to the microphones 1, 3, 4 and 6 are classified as a normal feature group, so that the microphones 2 and 5 can be diagnosed as faults.

In this case, the manner that generates features for fault detection using the VAD and classify the generated features into normal and abnormal groups may be implemented as various embodiments. For example, a feature group including a larger number of features is classified as the normal feature group, and a feature group including a smaller amount of features is classified as the abnormal feature group. Alternatively, a feature group including a larger number of features with similarity between features in a primarily classified group is classified as the normal feature group, and a feature group including a smaller number of features with similarity between features in the primarily classified group is classified as the abnormal feature group. When all of the plurality of feature groups have the same number of features as the classified result, a feature group including a larger number of features with similarity between features is classified as the normal feature group, and a group including a smaller number of features with similarity between features. This is because it is highly likely that since microphones that belong to the normal feature group output normal signals with respect to the same input signal, similar features are generated, and fault microphones output non-similar features with the same input signal.

The example is provided only for illustrative purposes and may be implemented by programming various methods.

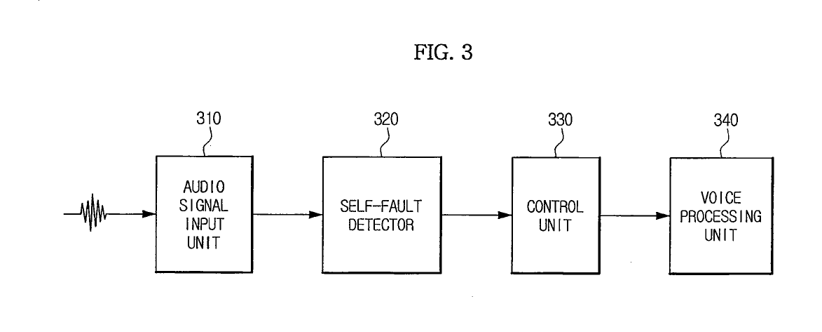

FIG. 3 is a configuration view of an audio-based device according an embodiment. The audio-based device may include a robot controlled through voice-based interaction, an apparatus including a voice processing system using an intelligent service robot and a microphone array, and the like. The voice processing system may include a sound source localization system, a blind source separation system, an automatic speech recognition system, and the like. The audio-based device according to the embodiment is controlled by receiving audio signals inputted to a plurality of microphones. In this case, the audio-based device detects a fault of a microphone by itself, and controls the audio signal inputted to the microphone diagnosed as the fault to be actively processed.

Referring to FIG. 3, the audio-based device includes an audio signal input unit 310, a self-fault detector 320 and a control unit 330, and may further include a voice processing unit 340.

An analog signal X^{a}ₜ including voice and non-voice is inputted through the audio signal input unit 310, the inputted analog signal X^{a}ₜ is converted into a digital signal X^{d}ₜ, thereby obtaining a signal X_{f} in a frequency domain.

The self-fault detector 320 analyzes audio signals respectively inputted to a plurality of microphones and diagnoses, as faults, microphones to which the corresponding audio signals with abnormal features are inputted. In this case, the description for the configuration according to the embodiment of FIG. 1 may be identically applied.

The control unit 330 in the audio-based device controls the audio signals respectively inputted to the microphones diagnosed as the faults to be processed based on the reference for defect tolerance of the system with respect to the microphones diagnosed as faults by the self-fault detector 320. That is, when information on the microphone diagnosed as the fault by the self-fault detector 320 is received, the control unit 330 diagnoses the defect tolerance of the system based on the number and position of the detected fault microphones and actively deals with the fault microphones using various methods.

Hereinafter, the implementation of the control unit 330 in the audio-based device based on the diagnosis result of the self-fault detector 320 will be described as an example.

In this case, the implementation of the control unit in the audio-based device will be described using a speaker position detector that is an embodiment of the voice-based interaction device.

For example, operation may be stopped or continuously performed by comparing the rate of abnormal microphones to normal microphones with a predetermined reference. When the operation is continuously performed, the detection of azimuth and elevation angles may be selectively performed using only the other microphones except the fault microphones in the measurement of the position of a speaker, and the rate of deterioration due to the fault may be determined in consideration of the similarity of features. When the number of fault microphones is considerable, the operation may be stopped to be suitable for conditions. The example is provided only for illustrative purposes, and may be implemented by programming various methods.

The voice processing unit 340 in the audio-based device normally performs, partially performs or stops operations of sound source localization, blind source separation and automatic speech recognition based on the result determined by the control unit 330 with respect to the state of the fault microphones.

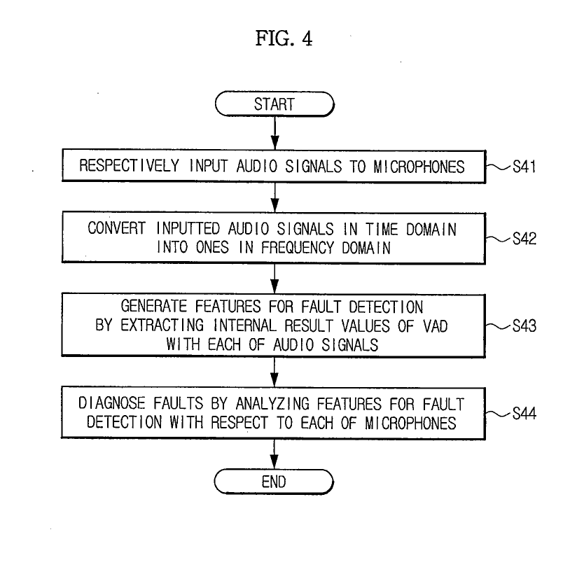

FIG. 4 is a flowchart illustrating a self-fault detection method in a microphone array system according to an embodiment.

Referring to FIG. 4, the self-fault detection method includes respectively inputting audio signals to a plurality of microphones (S41); forming features for fault detection by applying a VAD for each frame of the plurality of audio signal (S42); and extracting abnormal features by analyzing and grouping the plurality of features formed with the respective microphones, and diagnosing, as faults, microphones to which the corresponding audio signals with the abnormal features is inputted (S43).

In this case, the self-fault detection method may further include converting the audio signals in a time domain, respectively inputted to the plurality of microphones, into ones in a frequency domain.

The descriptions for the embodiments of FIGS. 1 to 3 are applied to the respective operations.

The self-fault detection system and method in the microphone array system using the VAD has advantages as follows.

The VAD is used in most voice-based interaction systems, for example, a sound source localization system, a blind source separation system and an automatic speech recognition system, because it is an indispensable part for speech signal processing to determine whether a frame of audio signal includes a voice signal. Therefore, as these features in VAD are used in fault detection, then extra processing for extraction of features is not required.

Self-fault detection in a microphone array is automatically accomplished in conversation, because self-fault detection in a microphone array is adopted using features extracted from the VAD. Thus, there is no generation of noises and specific signals (white noises, colored noises, sine waves, sinusoidal waves, time-stretched pulse (TSP) signals, etc), which becomes a reference for fault detection.

The features for fault detection are generated one by one as a representative value for each frame of the audio signals inputted through the VAD, so that the amount of data to be processed can be remarkably reduced.

While the disclosure has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. An audio-based device comprising:
an audio signal input unit having a plurality of microphones through which audio signals are respectively inputted;
a self-fault detector that analyzes the audio signals respectively inputted to the plurality of microphones and diagnoses, as faults, microphones to which corresponding audio signals with abnormal features are respectively inputted; and
a control unit that controls the audio signals respectively inputted from the microphones diagnosed as the faults to be processed based on a reference for defect tolerance of a system with respect to the microphones diagnosed as faults by the self-fault detector.

2. The audio-based device according to claim 1, wherein the control unit determines one of a partial operation after stopping the operation of the fault microphones, a normal operation after replacing the fault microphones, and a declaration of stopping the entire operation based on the reference for defect tolerance of the system with respect to the microphones diagnosed as faults by the self-fault detector.

3. The audio-based device according to claim 1, further comprising a voice processing unit that normally performs, partially performs or stops operations of sound source localization, blind source separation and automatic speech recognition based on the result determined by the control unit with respect to the state of the fault microphones.

4. A self-fault detection system in a microphone array system, the system comprising:
an audio signal input unit having a plurality of microphones through which audio signals are respectively inputted;
a feature generation unit that generates features for fault detection by extracting internal result values of a voice activity detector (VAD) that determines the presence of voice for each frame of the audio signals respectively inputted to the plurality of microphones; and
a feature classification unit that extracts abnormal features by analyzing and grouping the plurality of features formed with respect to each of the microphones and diagnoses, as faults, microphones to which corresponding audio signals with the abnormal features are respectively inputted.

5. The system according to claim 4, wherein the features for fault detection are generated by converting and normalizing the internal result values of the VAD in the feature generation unit.

6. The system according to claim 4, further comprising a frequency domain conversion unit that converts the audio signals in a time domain, respectively inputted to the plurality of microphones, into ones in a frequency domain.

7. A self-fault detection method in a microphone array system, the method comprising:
respectively inputting audio signals to a plurality of microphones;
extracting internal result values of a VAD that determines the presence of voice for each frame of the audio signals respectively inputted to the plurality of microphones, thereby generating features for fault detection; and
extracting abnormal features by analyzing and grouping the plurality of features formed with respect to each of the microphones, and diagnosing, as faults, microphones to which corresponding audio signals with the abnormal features are respectively inputted.

8. The method according to claim 7, wherein the features for fault detection are generated by converting and normalizing the internal result values of the VAD in the feature generation unit.

9. The method according to claim 7, further comprising converting the audio signals in a time domain, respectively inputted to the plurality of microphones, into ones in a frequency domain.
